(19) United States
(12) Patent Application Publication
(10) Pub. No.: US 2026/0192266 A1
(43) Pub. Date: Jul. 9, 2026

(54) MIXING CONTAINER

(71) Applicant: Foshan WinLin Smart Technology Co., Ltd, Foshan (CN)

(72) Inventor: Huiling ZENG, Foshan (CN)

(73) Assignee: Foshan WinLin Smart Technology Co., Ltd, Foshan (CN)

(21) Appl. No.: 19/023,181

(22) Filed: Jan. 15, 2025

(30) Foreign Application Priority Data
Jan. 9, 2025 (CN) 202520051168.9

(51) Int. Cl. B01F 27/63; A23G 9/04; A23G 9/22; B01F 101/14

(52) U.S. Cl. CPC B01F 27/63; A23G 9/045; A23G 9/224; B01F 2101/14

(57) ABSTRACT

The present disclosure relates to the technical field of drink making machines, and provides a mixing container provided with an arc-shaped baffle structure. The mixing container (20) is formed as a cylinder of a hollow structure and configured to accommodate a to-be-mixed finished product; an inwardly protruding flow disturbance baffle (20a) is formed on at least one side of the mixing container (20); and an arc-shaped baffle (20c) is formed along at least one end of the flow disturbance baffle (20a).

### RELATED APPLICATIONS

The present patent document claims the benefit of priority to Patent Application No. 202520051168.9, filed Jan. 9, 2025, and entitled “MIXING CONTAINER,” the entire contents of each of which are incorporated herein by reference.

### BACKGROUND

### 1. Technical Field

The present disclosure relates to the technical field of drink making machines, in particular to a mixing container.

### 2. Background Information

A frozen drink making machine is at least equipped with a mixing assembly in a mixing container, the mixing assembly is provided with a mixing blade or a twist drill rotated by a motor through a driving shaft and a driving assembly, and a compressor can receive a cooled drink product formed during preparation and processing of a condenser and an evaporator for a refrigerant. In addition, during mixing and stirring of the cooled drink product by the mixing blade or the twist drill, a portion located on an outer side of the mixing blade or the twist drill and attached to an inner wall of the mixing container may not be able to be fully stirred and may be attached to the inner wall of the mixing container, and the cooled drink product is poor in fluidity or is condensed on the inner wall of the mixing container, resulting in non-uniformity of the cooled drink product.

### BRIEF SUMMARY

The technical problem to be solved by the present disclosure is to provide a mixing container provided with an arc-shaped baffle structure, so as to solve the defect of the non-uniformity of the cooled drink product due to the fact that the cooled drink product is poor in fluidity or is condensed on the inner wall of the mixing container in the prior art.

The technical solution adopted by the present disclosure to solve the technical problem is to construct a mixing container applied to a frozen drink making machine, where
the mixing container is formed as a cylinder of a hollow structure and configured to accommodate a to-be-mixed finished product;
an inwardly protruding flow disturbance baffle is formed on at least one side of the mixing container; and
an arc-shaped baffle is formed along at least one end of the flow disturbance baffle.

In some embodiments, a stirring assembly rotating along a central axis is configured in a container cavity of the mixing container, and the stirring assembly mixes a to-be-mixed material upwards and rotationally in the container cavity to guide the to-be-mixed material to an end face of the arc-shaped baffle and a sealing baffle.

In some embodiments, an end face of the arc-shaped baffle is arranged adjacent to one end of the flow disturbance baffle.

In some embodiments, an open structure is arranged at one end of the mixing container, and the sealing baffle is arranged on an axial opposite side of the open structure; and
the arc-shaped baffle abuts against one end of the flow disturbance baffle and one end of the sealing baffle.

In some embodiments, an included angle is formed between an end face of the arc-shaped baffle and an end face of the sealing baffle which abut against each other.

In some embodiments, the flow disturbance baffle is positioned on a left side, a right side or an upper side of the container cavity.

In some embodiments, a protruding portion is formed on a lower end face of the buffer assembly and protrudes along an inner side of the container cavity.

In some embodiments, a feeding port is formed at the top of the mixing container, and a buffer assembly is arranged at a lower end of the feeding port.

In some embodiments, a protruding portion is formed on a lower end face of the buffer assembly and protrudes along an inner side of the container cavity.

In some embodiments, the arc-shaped baffle, the sealing baffle and the protruding portion are limited, so that the stirring assembly mixes a high position of the to-be-mixed material upwards and rotationally in the container cavity to guide the to-be-mixed material to the arc-shaped baffle, the sealing baffle or the protruding portion.

The mixing container in the present disclosure is formed as the cylinder of the hollow structure and configured to accommodate the to-be-mixed finished product; the inwardly protruding flow disturbance baffle is formed on at least one side of the mixing container; and the arc-shaped baffle is formed along at least one end of the flow disturbance baffle. Compared with the prior art, at least one flow disturbance baffle and at least one arc-shaped baffle are arranged in the mixing container to reduce mixtures adsorbed on a surface of an inner cavity of the mixing container and guide the to-be-mixed material in the mixing container to flow during stirring and mixing of the to-be-mixed material by the stirring assembly, which can effectively solve the problem of the non-uniformity of the cooled drink product due to the fact that the cooled drink product is poor in fluidity or is condensed on the inner wall of the mixing container.

### BRIEF DESCRIPTION OF THE DRAWINGS

The present disclosure will be further described below in conjunction with the accompanying drawings and embodiments. In the drawings:

FIG. 1 is a section view of an embodiment of a frozen drink making machine provided in the present disclosure;

FIG. 2 is a section view of another embodiment of a frozen drink making machine provided in the present disclosure;

FIG. 3 is a stereogram of an embodiment of a mixing container provided in the present disclosure;

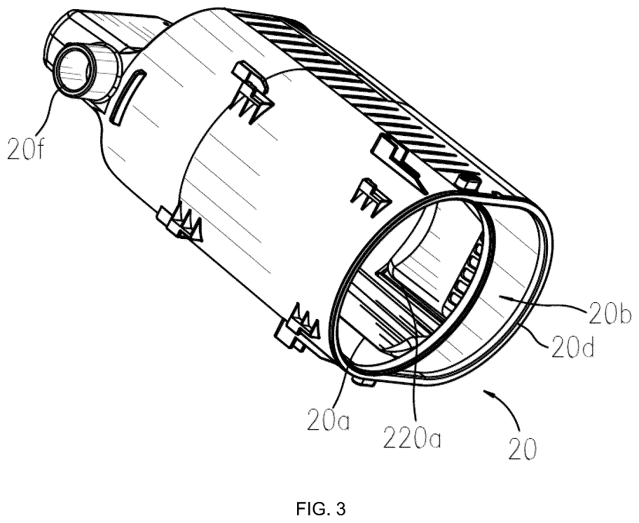

FIG. 4 is a section view of an embodiment of a mixing container provided in the present disclosure;

FIG. 5 is a stereogram of another embodiment of a mixing container provided in the present disclosure; and

FIG. 6 is a stereogram of another embodiment of a mixing container provided in the present disclosure.

### DETAILED DESCRIPTION OF THE DRAWINGS AND THE PRESENTLY PREFERRED EMBODIMENTS

To understand the technical features, purposes and effects of the present disclosure more clearly, the particular embodiments of the present disclosure are now described in detail with reference to the accompanying drawings.

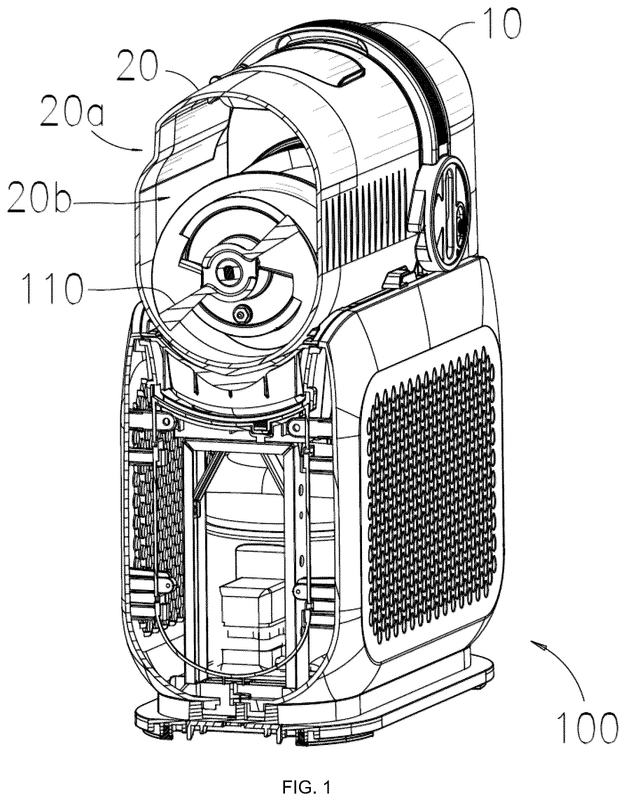

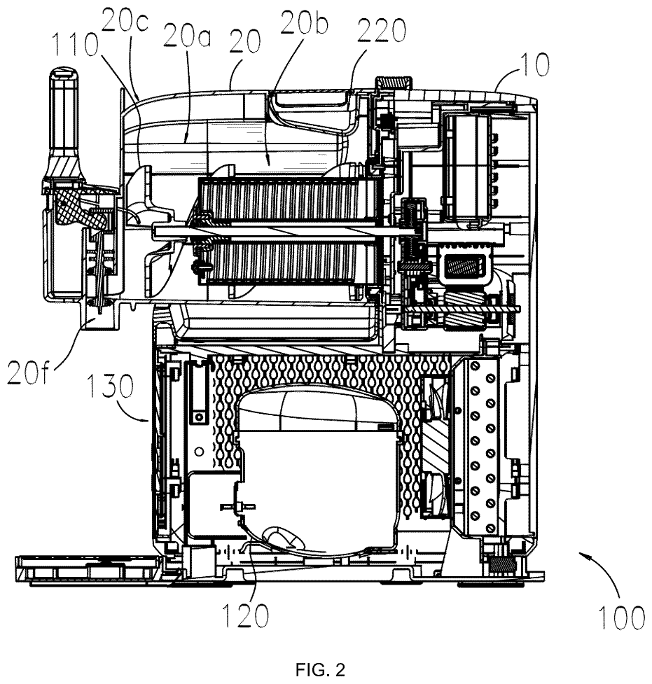

As shown in FIG. 1-FIG. 2, in a first embodiment of a frozen drink making machine in the present disclosure, the frozen drink making machine 100 includes a shell 10, a mixing container 20, a compressor 120, and a touch control panel 130.

The mixing container 20 is configured at a front end of the frozen drink making machine 100, is a cylinder of a hollow structure 20b, and is configured to accommodate ice cubes, slush ice or a to-be-mixed finished product.

A stirring assembly 110 is configured within the hollow structure (corresponding to a container cavity 20b) of the mixing container 20.

The compressor 120 compresses a refrigerant into high-temperature and high-pressure steam which is converted into a liquid after being cooled by a condenser, then the liquid is decompressed by an expansion valve to enter an evaporator, and rapid cooling is achieved after a large amount of heat is absorbed, thereby achieving the refrigeration effect.

An electric motor delivers finished products of the ice cubes or slush ice into the mixing container 20, then fruits or drinks in the mixing container 20 are cut into small cubes by the stirring assembly 110 configured inside the mixing container 20, and stirring and uniform mixing are performed through a stirring shaft, thereby making cold drinks such as slush ice, juice and milk shakes.

The touch control panel 130 is configured for a man-machine interaction.

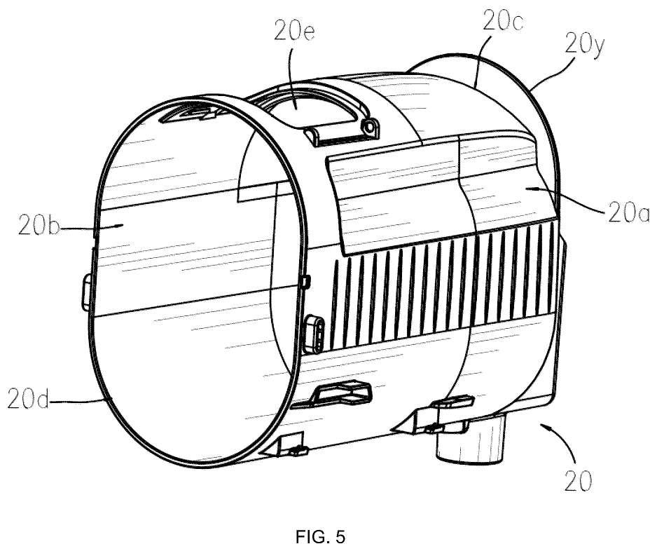

In a first embodiment of the mixing container in the present disclosure as shown in FIG. 1 and FIG. 5, the mixing container 20 is configured at a front end of the shell 10, is the cylinder of the hollow structure 20b, and is configured to accommodate the to-be-mixed finished product.

An inwardly (in a direction of the container cavity 20b) protruding flow disturbance baffle 20a is formed on at least one side of the mixing container 20.

When a plurality of flow disturbance baffles 20a are configured, they can be positioned on a left side, a right side or an upper side of the container cavity 20b.

An arc-shaped baffle 20c is formed along at least one end of the flow disturbance baffle 20a, and an arc-shaped surface thereof extends downwards towards the touch control panel 130.

Specifically, when the stirring assembly 110 stirs the to-be-mixed material in the mixing container 20, the to-be-mixed material flows in a rotation direction of the stirring assembly 110, when the to-be-mixed material is guided by the stirring assembly 110 to the flow disturbance baffle 20a and the arc-shaped baffle 20c, part of the to-be-mixed material is blocked by the flow disturbance baffle 20a and the arc-shaped baffle 20c, the to-be-mixed material falls down due to the dead weight, mixtures adsorbed on a surface of an inner cavity of the mixing container 20 can be reduced, and the fluidity of the to-be-mixed material in the mixing container 20 can be improved, so that the problem of the non-uniformity of the cooled drink product due to the fact that the cooled drink product is poor in fluidity or is condensed on the inner wall of the mixing container 20 can be effectively solved.

In some embodiments, as shown in FIG. 2, the stirring assembly 110 capable of rotating along a central axis can be configured in the container cavity 20b of the mixing container 20 to improve the stirring uniformity of the to-be-mixed material.

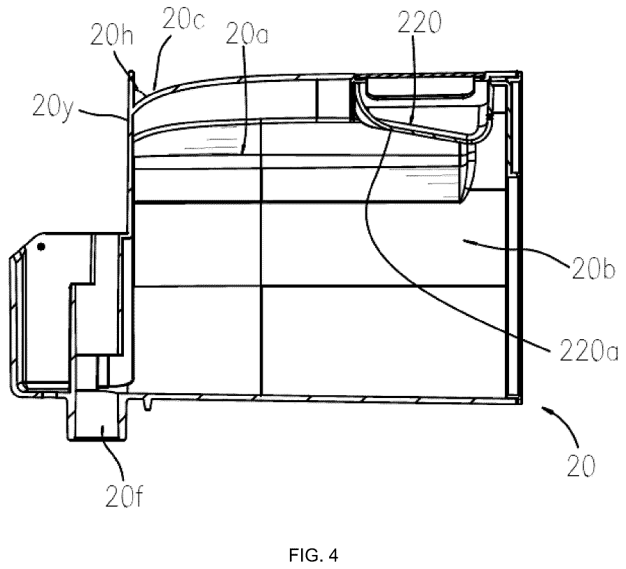

As shown in FIG. 4, a sealing baffle 20y for sealing one end of the container cavity 20b is arranged at an arc-shaped end of the arc-shaped baffle 20c, the arc-shaped baffle 20c and the sealing baffle 20y are limited such that the stirring assembly 110 mixes a high position of the to-be-mixed material upwards and rotationally in the container cavity 20b to guide the to-be-mixed material to an inner end face of the arc-shaped baffle 20c and an inner end face of the sealing baffle 20y, and the guided to-be-mixed material falls down from an inner side of the arc-shaped baffle 20c.

An end face of the arc-shaped baffle 20c is arranged adjacent to one end of the flow disturbance baffle 20a.

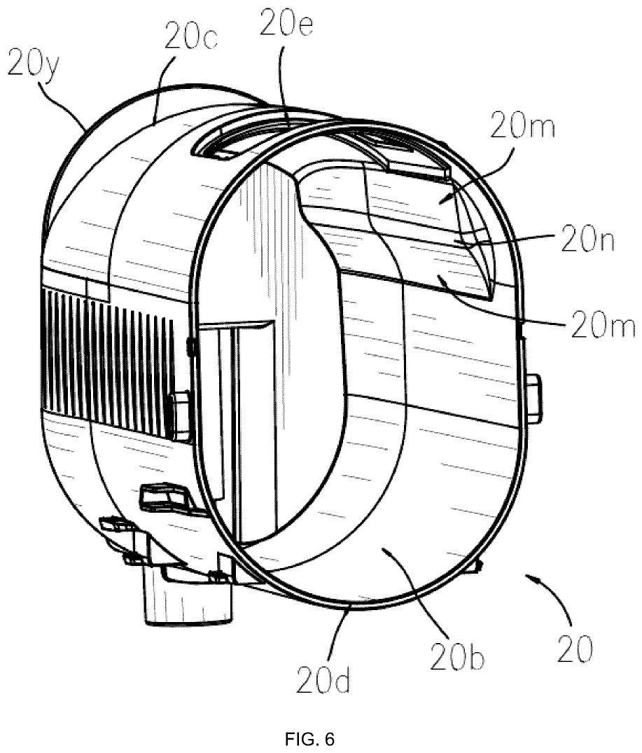

In some embodiments, as shown in FIG. 5 and FIG. 6, an open structure 20d is arranged at one end of the mixing container 20, and the sealing baffle 20y is arranged on an axial opposite side of the open structure 20d.

An end face of the arc-shaped baffle 20c abuts against one end of the flow disturbance baffle 20a and one end of the sealing baffle 20y, and the stirred mixtures are pushed to one side of the sealing baffle 20y through the stirring assembly 110 and then are output through a discharging assembly 20f.

In some embodiments, as shown in FIG. 4, an included angle 20h is formed between an upper end face of the arc-shaped baffle 20c and an end face of the sealing baffle 20y which abut against each other, and the included angle 20h can be 20-30 degrees.

In some embodiments, as shown in FIG. 6, to improve the blocking effect of the flow disturbance baffle 20a on the to-be-mixed material, an inward protrusion 20n can be arranged at a middle portion of the flow disturbance baffle 20a relative to a section of the container cavity 20b and forms slopes of 20m towards two sides, and the slopes of 20m can be 10-20 degrees.

In some embodiments, as shown in FIG. 5 and FIG. 6, to ensure the material feeding reliability, a feeding port 20e can be formed at the top of the mixing container 20, and a buffer assembly 220 is arranged at a lower end of the feeding port 20e.

In some embodiments, as shown in FIG. 4, to improve the blocking effect of the buffer assembly 220 on the to-be-mixed material, a protruding portion 220a can be formed on a lower end face of the buffer assembly 220 and protrudes along an inner side of the container cavity 20b, the protruding portion 220a has one high end and the other low end, and the low end is adjacent to one side of the open structure 20d.

The arc-shaped baffle 20c, the sealing baffle 20y and the protruding portion 220a are limited, so that the stirring assembly 110 mixes the high position of the to-be-mixed material upwards and rotationally in the container cavity 20b to guide the to-be-mixed material to the end face of the arc-shaped baffle 20c, the sealing baffle 20y or the protruding portion 220a; and the arc-shaped baffle 20c, the sealing baffle 20y and the protruding portion 220a can block the guided to-be-mixed material, so that the to-be-mixed material falls down due to the dead weight, and the phenomenon that the to-be-mixed material is condensed or attached to the inner wall of the mixing container 20 can be reduced or avoided.

The embodiments of the present disclosure are described above in conjunction with the accompanying drawings. However, the present disclosure is not limited to the above particular embodiments. The above particular embodiments are only exemplary and are not restrictive. With the motivation from the present disclosure, those of ordinary skill in the art can make many forms without departing from the purpose of the present disclosure and the scope of protection of the claims, and all these forms fall within the protection of the present disclosure.

1. A mixing container applied to a frozen drink making machine, wherein
the mixing container is formed as a cylinder of a hollow structure and configured to accommodate a to-be-mixed finished product;
an inwardly protruding flow disturbance baffle is formed on at least one side of the mixing container; and
an arc-shaped baffle is formed along at least one end of the flow disturbance baffle.

2. The mixing container according to claim 1, wherein
a stirring assembly rotating along a central axis is configured in a container cavity of the mixing container, and the stirring assembly mixes a to-be-mixed material upwards and rotationally in the container cavity to guide the to-be-mixed material to an end face of the arc-shaped baffle and a sealing baffle.

3. The mixing container according to claim 2, wherein
an end face of the arc-shaped baffle is arranged adjacent to one end of the flow disturbance baffle.

4. The mixing container according to claim 3, wherein
an open structure is arranged at one end of the mixing container, and the sealing baffle is arranged on an axial opposite side of the open structure; and
the arc-shaped baffle abuts against one end of the flow disturbance baffle and one end of the sealing baffle.

5. The mixing container according to claim 4, wherein
an included angle is formed between an end face of the arc-shaped baffle and an end face of the sealing baffle which abut against each other.

6. The mixing container according to claim 5, wherein
the flow disturbance baffle is positioned on a left side, a right side or an upper side of the container cavity.

7. The mixing container according to claim 6, wherein
a middle portion of the flow disturbance baffle raises inwardly relative to a section of the container cavity, and forms slopes towards two sides.

8. The mixing container according to claim 7, wherein
a feeding port is formed at the top of the mixing container, and a buffer assembly is arranged at a lower end of the feeding port.

9. The mixing container according to claim 8, wherein
a protruding portion is formed on a lower end face of the buffer assembly and protrudes along an inner side of the container cavity.

10. The mixing container according to claim 9, wherein
the arc-shaped baffle, the sealing baffle and the protruding portion are limited, so that the stirring assembly mixes a high position of the to-be-mixed material upwards and rotationally in the container cavity to guide the to-be-mixed material to the arc-shaped baffle, the sealing baffle or the protruding portion.
